(19) United States
(12) Patent Application Publication
(10) Pub. No.: US 2004/0007841 A1
(43) Pub. Date: Jan. 15, 2004

(54) Children tricycle

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/191,069

(22) Filed: Jul. 10, 2002

(51) Int. Cl. B60G 1/00

(52) U.S. Cl. 280/87.1

(57) ABSTRACT

A structure of a children tricycle having respectively provided to both sides of its crossbar a hollow sleeved tube to receive insertion by a central tube and two sleeved tubes connected to both sides of the central tube extending from a rear wheel frame; at least one perforation is punched respectively in each of both sleeved tubes from the crossbar and both sleeved tubes from the central tube of the rear wheel frame for two fixation bolts at the bottom of a seat to penetrate through the overlapped perforations from the sleeved tubes of the crossbar and those connected to the central tube from the rear wheel frame when the central tube together with its both sleeved tubes being inserted into the crossbar and both sleeved tubes of the crossbar, and to expose below the sleeved tubes of the crossbar to be locked up each with nuts to form an integral tricycle or both bolts being loosened up to disengage the seat from the crossbar and to separate the tricycle into three parts, the seat, the crossbar including the front wheel and the rear wheel frame for storage.

### BACKGROUND OF THE INVENTION

(a) Field of the Invention

The present invention relates to a tricycle for children, and more particularly, to one having a mobile connection between a crossbar and a rear wheel frame and said connection further defines a fixation mechanism in relation to a seat so that the entire tricycle can be knocked down into three major parts to facilitate storage.

(b) Description of the Prior Art

To ensure safe and stable riding, a frame of a toy vehicle for fun riding by children is usually made in a form of that for a tricycle. Wherein, a fork is pivoted to the front of the crossbar, a handle is connected to the upper part of the fork; a front wheel is pivoted to the lower part of the fork; a pair of crank pedals is directly provided to the axis of the front wheel; the rear end of the crossbar is fixed to a rear wheel frame with both ends of the rear wheel frame respectively fixed to a rear wheel; and a seat is provided on the crossbar to form an integral children tricycle. When in use, the child sits on the seat and uses his/her feet to step on the pedals to drive the tricycle forwardly or backwardly, and makes turns by the handle connected with the fork.

However, the children tricycle of the prior art is basically in fixed configuration and it consumes a larger space for storage. Therefore, a retractable design for the children tricycle is required. Retractable children tricycles generally available in the market usually provide a plurality of foldable joints to the frame for reducing either of the width, length, or both of the body of the tricycle. By folding the tricycle for storage, it takes more time and efforts. Furthermore, much more components are required for the fabrication of the joints and their associated positioning structures. More components and structures result in higher production cost, and higher production cost weakens competition in the market of children bicycles, which are at lower price end.

### SUMMARY OF THE INVENTION

The primary purpose of the present invention is to provide a structure of children tricycle. The tricycle is divided into three major parts, a rear wheel frame, a seat and a crossbar containing a front wheel, that can be separated to facilitate storage. To achieve the purpose, the rear wheel frame of the body is connected to the crossbar by insertion and the connection is further fixed when adapted with the seat characterized by that:

two hollow sleeved tubes bending backwardly being respectively fixed to both sides of the rear of the crossbar; the rear end of the crossbar being a hollow tube; at least one perforation being provided in each sleeved tube; the rear wheel frame having connected to its forwardly a central tube, and having at both sides of the central tube connected to two hollow sleeved tubes corresponding to those two from the crossbar so that the central tube and its both sleeved tubes are merely and respectively inserted into the crossbar and its two sleeved tubes; at least one perforation corresponding to that in each sleeved tube of the crossbar is provided in each sleeved tube from the central tube of the rear wheel frame; two fixation bolts being provided at the bottom of the seat to pass through their respective perforations of the sleeved tubes from the crossbar and the sleeved tubes connected to the central tube from the rear wheel frame when the central tube is inserted into the crossbar, thus for the seat to be fixed in position with nuts to lock up the exposed bolts to complete the assembly of the children tricycle. On the other hand, when the tricycle is not used, simply by loosening both nuts to separate the seat from the crossbar, then separating both of the crossbar and the rear wheel frame from each other for storage.

### BRIEF DESCRIPTION OF THE DRAWINGS

FIG. 1 is an exploded view of a preferred embodiment of the present invention;

FIG. 2 is a perspective view of an assembly of the preferred embodiment of the present invention;

FIG. 3 is a partly sectional view of the assembly of the preferred embodiment of the present invention;

FIG. 4 is a partly top view of the assembly of the preferred embodiment of the present invention; and

FIG. 5 is a view showing adjustment of the position of a seat in the preferred embodiment of the present

### DETAILED DESCRIPTION OF THE PREFERRED EMBODIMENTS

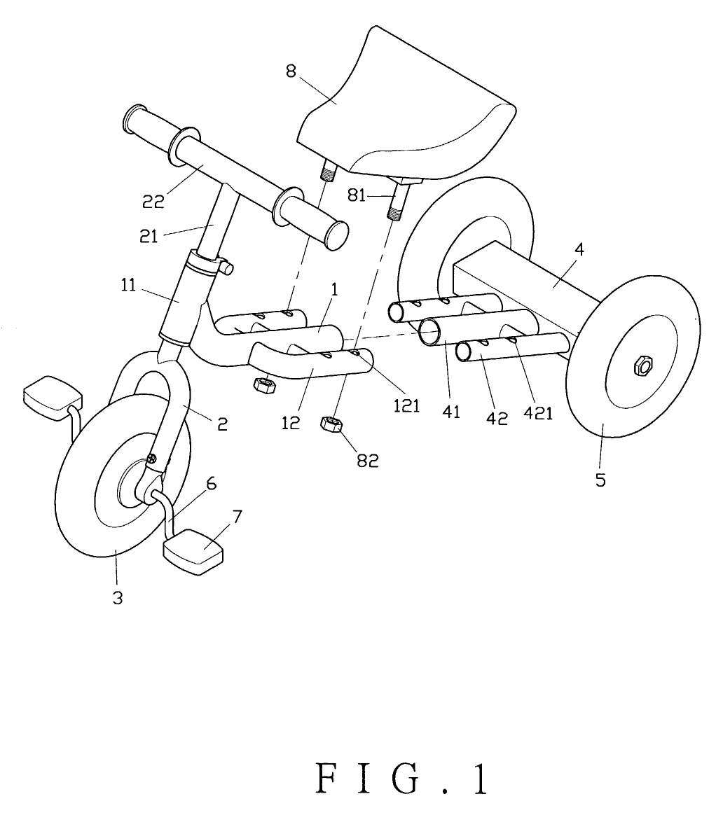

As illustrated in FIG. 1, a children tricycle of the present invention essentially comprises a crossbar (1) having its front end connected to a head tube (11), a fork (2) inserted through the head tube (11), a front wheel (3) pivoted to the lower end of the fork (2), a rear wheel frame (4) connected to the rear of the crossbar (1), two rear wheels (5) connected to both sides of the rear wheel frame (4), a crank shaft (6) with two pedals (7) pivoted to the axis of the front wheel (3), the fork (2) having an upper tube (21) extending from the upper end of the head tube (11) and then connected to a handle (22). The rear wheel frame (4) is connected by insertion to the crossbar (1) and a seat (8) is relatively fixed through such connection.

Two hollow sleeved tubes (12) bending backwardly are respectively connected on the same plane to the rear of the crossbar (1) being an open hollow tube and at least one perforation (121) is each punched in both sleeved tubes (12).

A central tube (41) extends forwardly from the rear wheel frame (4) and two sleeved tubes (42) are connected to both sides of the central tube (41). The central tube (41) and the sleeved tubes (42) are respectively and merely inserted into the crossbar (1) and both sleeved tubes (12) connected to the crossbar (1). At least one perforation (421) corresponding to the perforation (121) of the sleeved tube (12) is each punched in both sleeved tubes (42).

The bottom of the seat (8) provides two fixation bolts (81) at where respectively corresponding to the perforations (121) of the sleeved tubes (12) and the perforations (421) of the sleeved tubes (42).

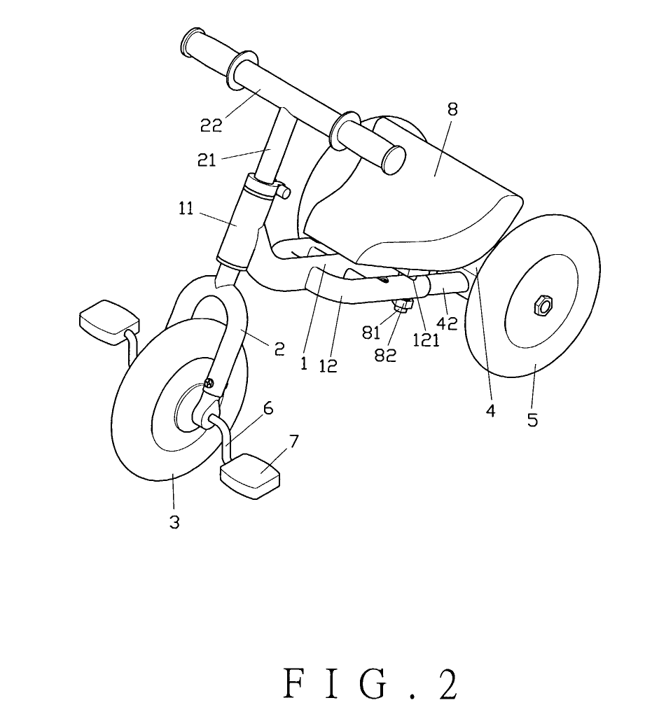

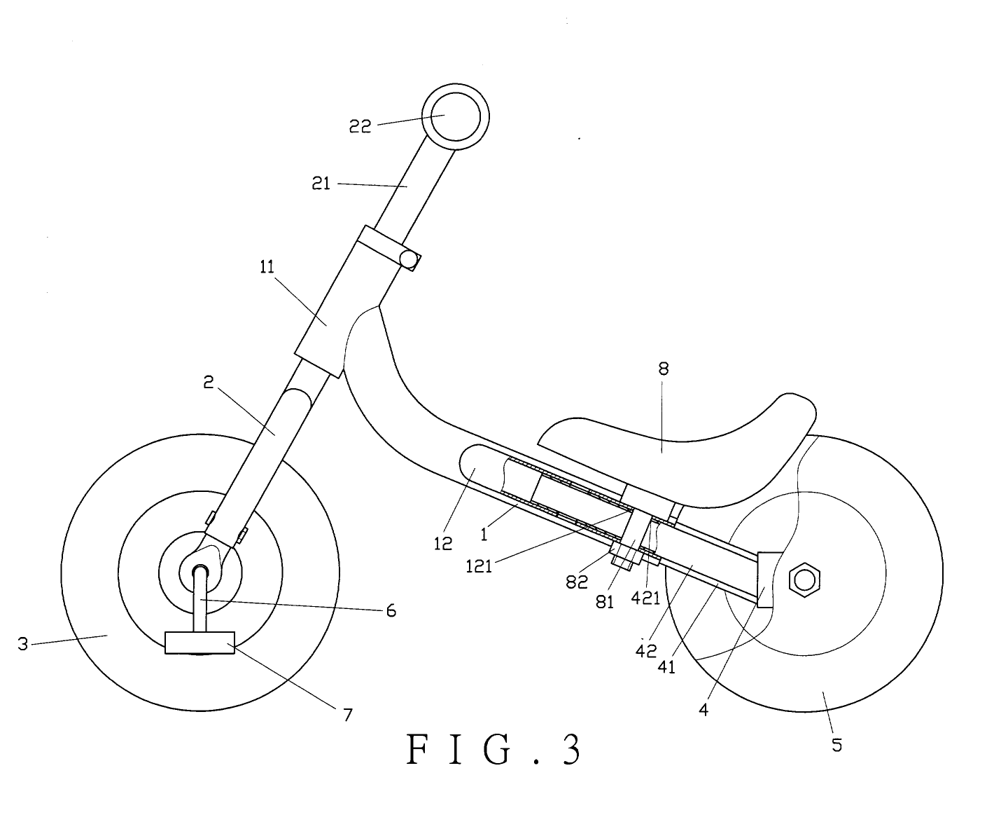

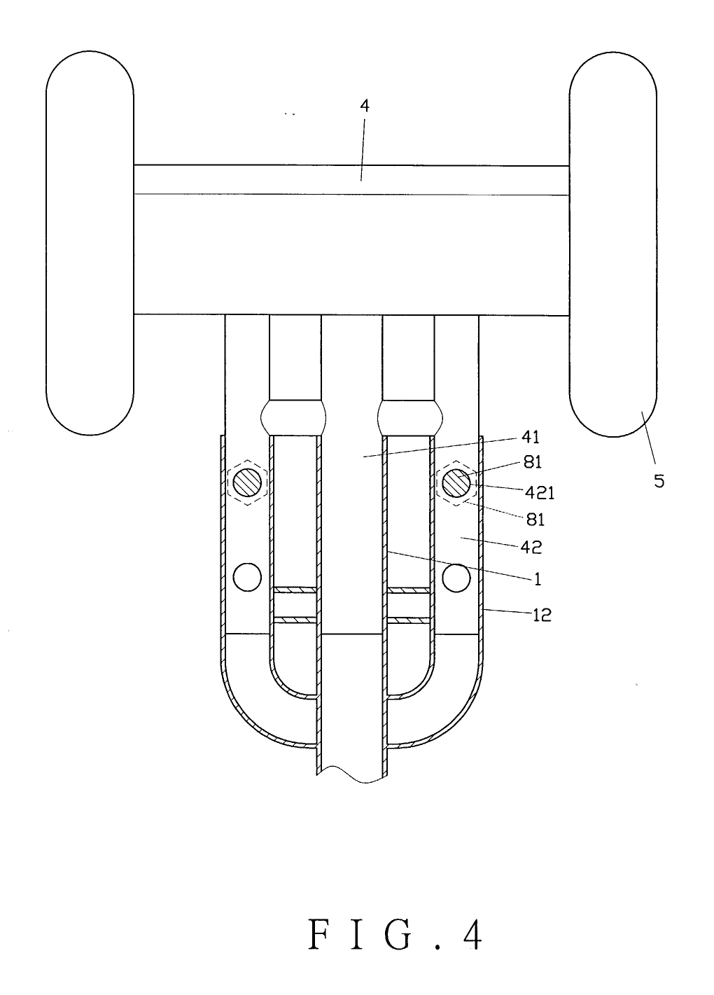

Upon assembling the body of the children tricycle as illustrated in FIGS. 2, 3 and 4, the central tube (41) and its both sleeved tubes (42) from the rear wheel frame (4) are inserted respectively into the opening rear end of the crossbar (1) and both sleeved tubes (12) from the crossbar (1) with each perforation (421) in the sleeved tube (42) to be overlapped with the perforation (121) in the sleeved tube (12) from the crossbar (1) for both fixation bolts (81) at the bottom of the seat (8) to pass through the perforation (421) of the sleeved tube (42) and the perforation (121) of the sleeved tube (12) from the crossbar (1) and expose below the sleeved tubes (12), thereby, a nut (82) is each used to lock up the fixation bolt (81) and press against the outer wall below the sleeved tube (12) to form an integral children tricycle.

As illustrated in FIG. 1, when the children tricycle is required to be stored, simply loosen up both nuts (82) to disengage the seat (8) from the crossbar (1) and both fixation bolts (81) at the bottom of the seat (8) are removed from the perforation (421) of the sleeved tube (42) from the rear wheel frame (4) and the perforation (121) of the sleeved tube (12) from the crossbar (1) to separate the rear wheel frame (4) from the crossbar (1). Consequently, the children tricycle is divided into three major parts, respectively, the rear wheel frame (4), the seat (8) and the crossbar (1) including the front wheel to facilitate storage.

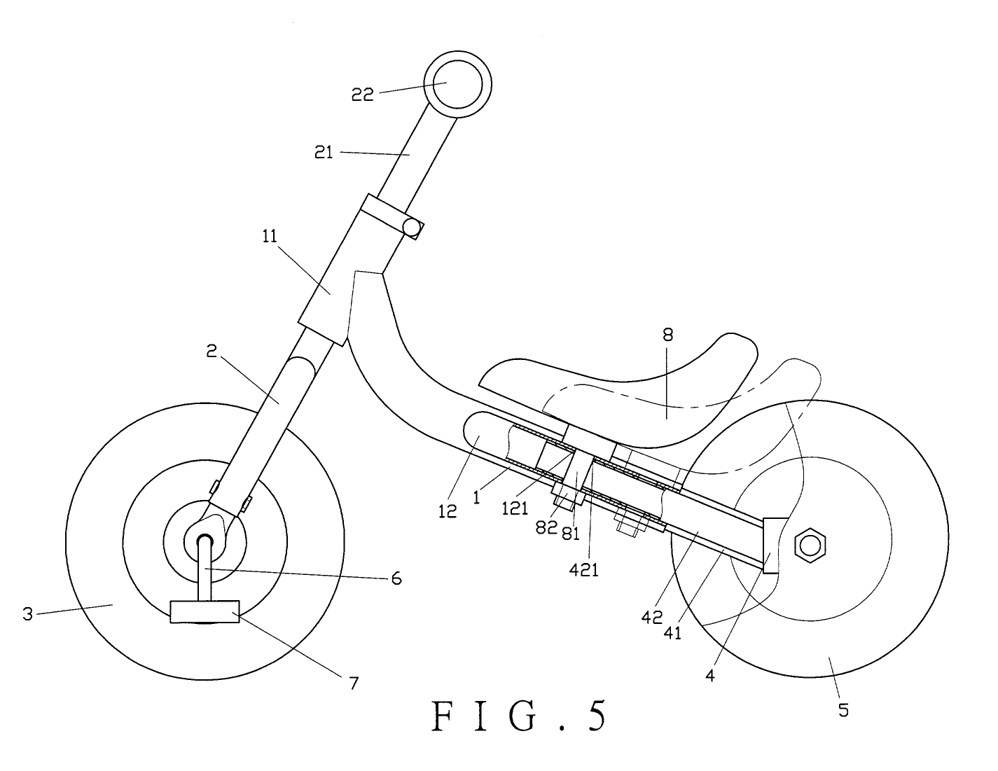

Now referring to FIG. 5, two or more than two perforations (421) and perforations (121) may be respectively provided to each of both sleeved tubes (42) from the rear wheel fame (4) and the sleeved tubes (12) from the crossbar (1) so to offer the option for the adjustment of the position of the seat (8) along the crossbar (1).

A children tricycle of the present invention by having the rear wheel frame to be connected by insertion to the crossbar and having the seat to be relatively fixed through the connection to allow compact design of the tricycle and separation from one another of the rear wheel frame, the seat and the crossbar including the front wheel to facilitate storage is innovative, practical and advancing.

I claim:

1. A children tricycle structure having a mobile connection is made between a rear wheel frame and a crossbar of the body and a seat is relatively fixed through the connection; wherein,
two hollow sleeved tube bending backwardly are respectively connected on the same plane to the rear of said crossbar with the rear end of said crossbar being an open hollow tube and at least one perforation being each punched in both sleeved tubes;
a central tube extending forwardly from said rear wheel frame and two sleeved tubes being connected to both sides of said central tube; said central tube and its both sleeved tubes being respectively and merely inserted into said crossbar and both sleeved tubes connected to said crossbar; and at least one perforation corresponding to said perforation of said sleeved tube of said crossbar being each punched in said sleeved tubes; and
at the bottom of said seat providing two fixation bolts at where respectively corresponding to said perforations of said sleeved tubes from said crossbar and said perforations of said sleeved tubes connected to said rear wheel frame; characterized by that:
said seat being fixed to said crossbar by having said fixation bolts to pass through said perforations of said sleeved tubes from said crossbar and those from said rear wheel frame when said central tube of said rear wheel frame being connected to said crossbar, and said exposed bolts being each locked with a nut to form an integral children tricycle; and by loosening said nuts to disengage said seat from said crossbar to knock down the tricycle into three parts, said rear wheel frame, said seat and said crossbar including said front wheel for easy storage.

2. A children tricycle structure as claimed in claim 1, wherein, more than two perforations are respectively provided to each of both sleeved tubes of said rear wheel frame and said sleeved tubes of said crossbar for adjustment of the position of said seat along said crossbar.
